(19) United States
(12) Patent Application Publication
(10) Pub. No.: US 2001/0035088 A1
(43) Pub. Date: Nov. 1, 2001

(54) Electronic device with upload & download memory transfer & storage

(76) Inventor: Bradley Scott Faecher, Sudbury, MA (US)

Correspondence Address: Bradley S. Faecher, 510 Peakham Road, Sudbury, MA, 01776, US

(21) Appl. No.: 09/796,260

(22) Filed: Feb. 28, 2001

Related U.S. Application Data
(60) Provisional application No. 60/186,244, filed on Mar. 1, 2000.

(51) Int. Cl. G10H 1/26

(52) U.S. Cl. 84/609

(57) ABSTRACT

An electronic device capable of receiving & transmitting digital code via a detachable cable or wireless transmission of data via an infrared port to and from a “PC”—personal computer or similar serving device.

The device may be an electronic musical instrument and/or electronic LCD game that implements a electronic memory that allows the user to transfer additional “code” to change the game theme for the LCD game embodiment and music style (rock, country, hip hop, jazz, etc.) for the electronic musical instrument embodiment. Therefore, data may transferred by using a cable and attached to said unit. The other end of the cable shall be connected to the serial or parallel port of a “PC”—personal computer or other computer server. Additionally, a wireless infrared port capable of receiving and transmitting data may be used to facilitate said data transfer in a similar manner. The PC may access the additional code from an internet site, computer disk or CD-ROM. Said inventions may also customize code & upload to the PC to create a permanent record of the new customized code for later use or modification.

### FIELD OF INVENTION

The present invention relates to devices capable of uploading & downloading data. More particularly, this invention relates to electronic toys & consumer electronics with an emphasis on electronic musical instruments & electronic games which can change operating code via a transfer of data from a personal computer or computer server.

### BACKGROUND & SUMMARY OF THE INVENTION

A variety of toys specifically talking dolls, action figures & talking teddy bears have implemented a design to change voice output of a doll or action figure by different audio files. Sharpe et al. (2000) U.S. Pat. No. 6,012,961, Rifkin et al. (1999) U.S. Pat. No. 5,873,765

However, there has not been any recognition of the art to implement an electronic musical instrument such as a guitar to have the ability to change the operating code via a transfer of information from a storage medium such as a CD-ROM & PC “personal computer” and thus, allowing for an unlimited variety of music styles for the user to enjoy.

Additionally, there has not been any recognition of an electronic game such as (LIQUID CRYSTAL DISPLAY) LCD game to have its operating digital code via a similar manner of transfer to allow for a greater variety game play & advancement of the art. Previous art such as Stambolic et al (1999) U.S. Pat. No. 5,893,798, Stambolic et al (1997) U.S. Pat. No. 5,685,776, Kawai et al, (1996) U.S. Pat. No. 5,572,646, Kitaue et al (1993) U.S. Pat. No. 5,213,327 related to LCD games however, said inventions do not have the capability to download or upload additional operating code and thus, cannot change the game play or have unlimited variations of play.

The previous art also has not included the ability to customize code from a “toy” and upload to the computer to save the customized program for later use.

Previous art for electronic musical instruments/musical toys, Wallace et al (1992) U.S. Pat. No. 5,095,799, Segan, et al (1992) U.S. Pat. No. 5,121,668, Corigan III et al (1989) U.S. Pat. No. 4,794,838 have not advanced the art as such to allow unlimited varieties and styles of music (i.e. “rock n roll”, jazz, country etc.) to be played by a single instrument. The former either used a permanent memory in which only one style of music may be played or a memory cartridge system. The former allows for a limited play value & market desirability. Additionally, cartridge systems are costly to manufacture. Also, retail venders rarely find it economically desirable to carry said cartridges in inventory for a pleura of merchandising & consumer related logistics.

LCD display games in a parallel manner have either one set code in its permanent ROM (read only memory) or a similar situation with replaceable cartridges.

The previous art only allowed for data transfer from the host computer to the toy. However the current embodiments allow for customized code to be made by the musical instruments/LCD game & transmitted back to the Host PC. Said customized code may in turn be uploaded to a PC and a permanent file can be saved on the hard drive or other permanent storage peripheral of said computer. The preceding allows the aforementioned customized code to be downloaded again at a different time.

The invention/s may also interact with other units of similar style via tethered cord or infrared ports. An example of this would be Guitar “A” would receive a download. Guitar “B” would receive another download of code. Once both unit are programmed they may in turn interact with each other & users can play music in tandem.

Another example of this would be LCD game “A” receives new digital code then LCD game “B” receives a download also. Now players can interact with each other via the included tethered cable or infra red port on each respective unit.

Another embodiment allows the guitar to interact with the computer via the detachable data cable. The user can interact with the PC based software & output the music composition via the sound card & speaker system of the computer.

The LCD game variation would allow the user to play against the PC computer. The software included with the CD- ROM would allow for such play.

It also should be noted that the aforementioned embodiments may also acquire additional code variations from the internet or other remote computer site. The units may also interact with the server (computer) site.

Additionally, the LCD game may also have incorporated into the design a voice modulated LCD that may have a multitude of facial caricatures. Therefore, the downloaded code will actuate said animated LCD face. In addition, the user may customize the code & voice/sound output of said LCD face & upload the modified code to the computer for later use or place on the internet site for others users to share as well.

### DESCRIPTION OF THE DRAWINGS

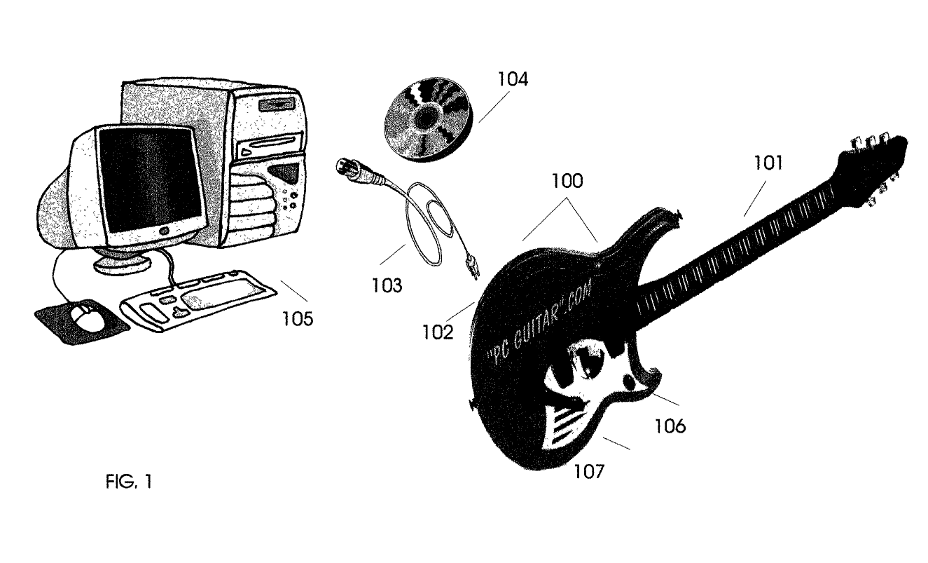

1)FIG. 1 is a looks like embodiment of the electronic guitar musical instrument.

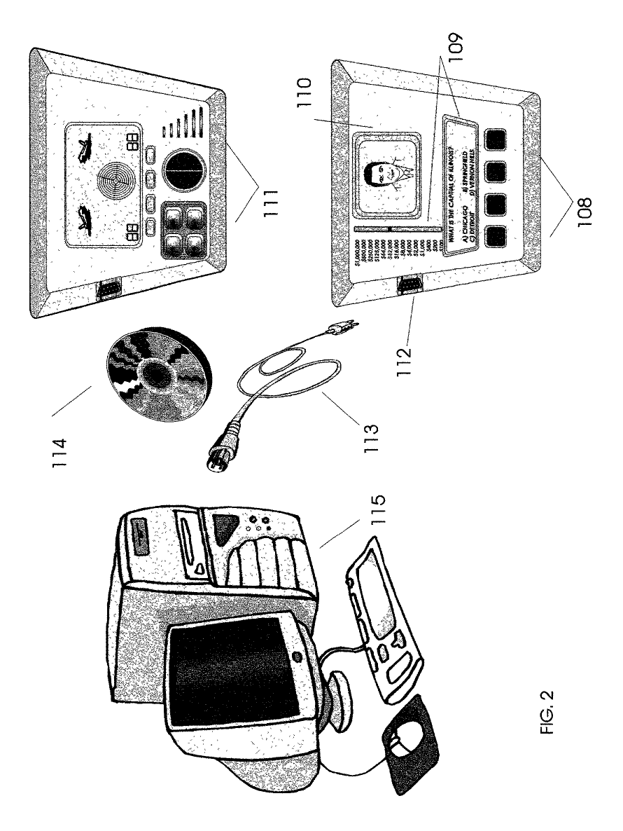

2)FIG. 2 is a looks like embodiment of the LCD game.

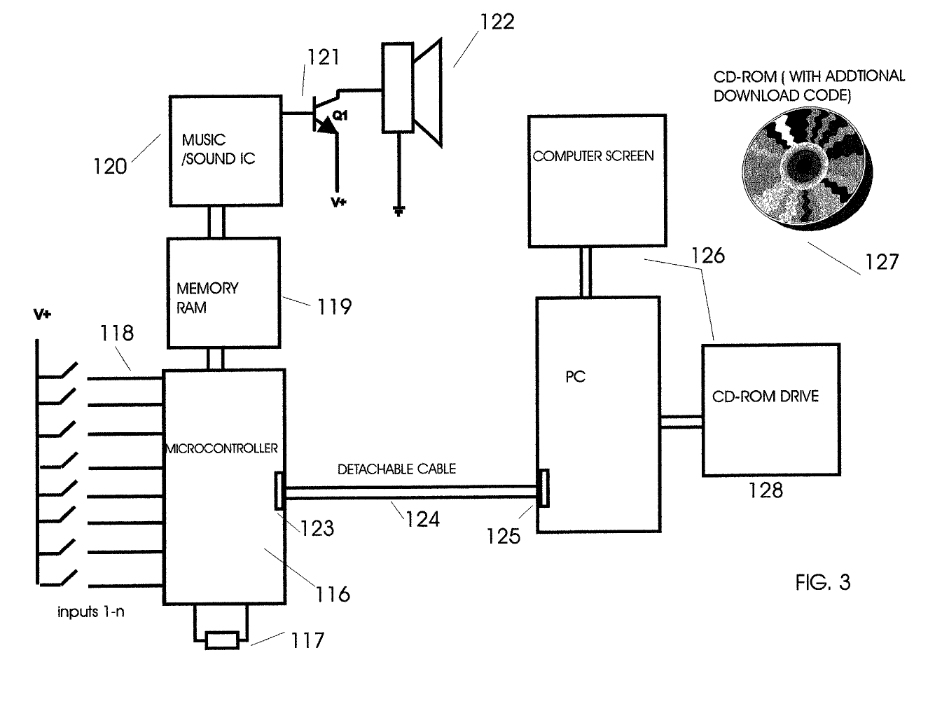

3) FIG. 3 represents the guitar schematic using the detachable cable to interface to the PC—Personal computer.

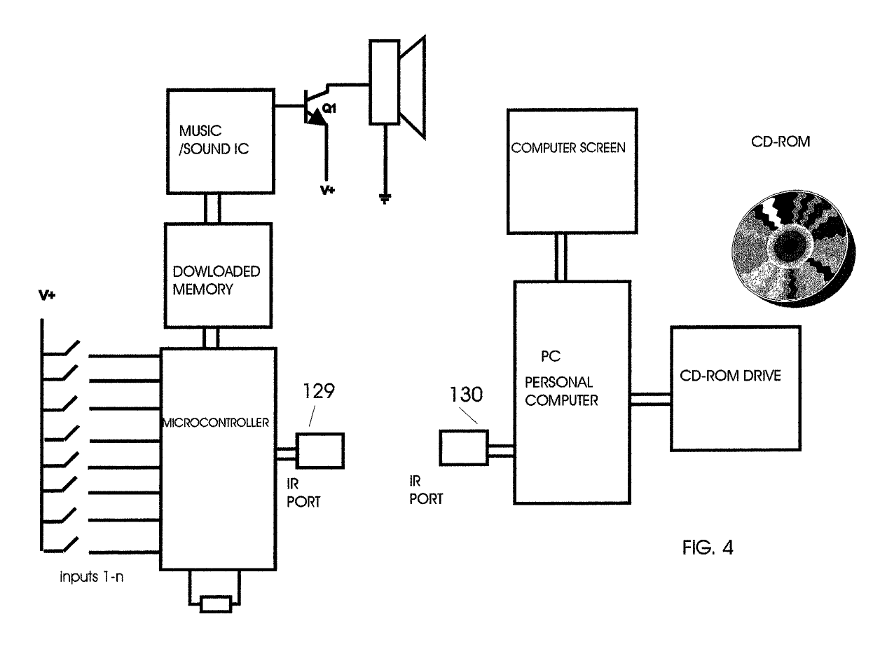

4) FIG. 4 represents the guitar schematic using the wireless infrared port to the PC—Personal computer.

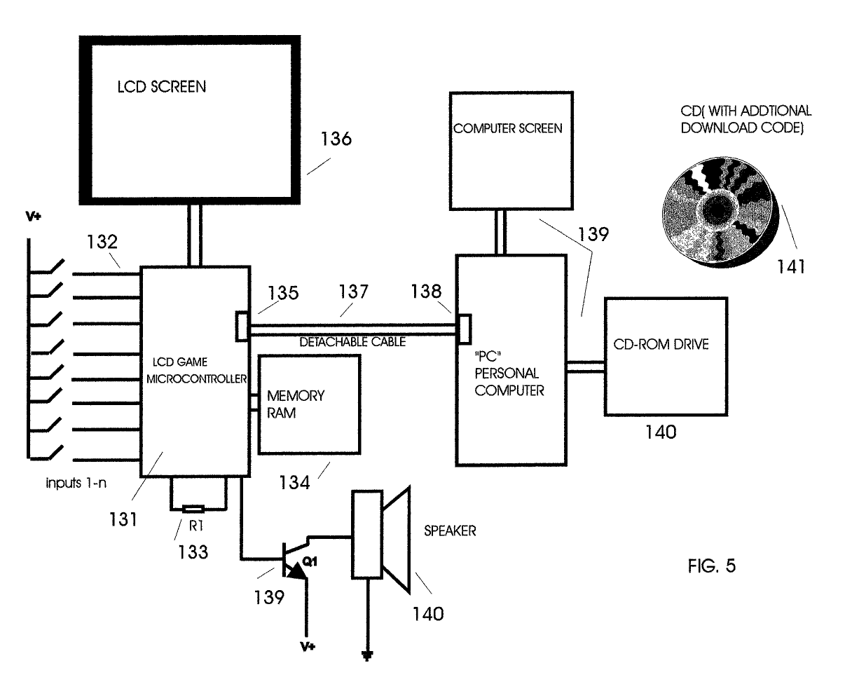

5) FIG. 5 represents the LCD game schematic using the detachable cable to interface to the PC—Personal computer.

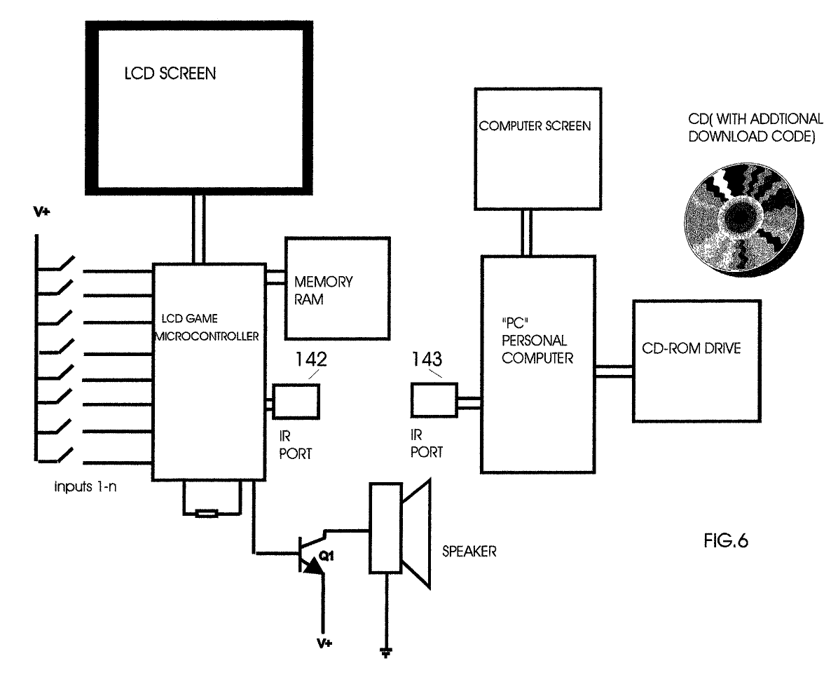

6) FIG. 6 represents the LCD game schematic using the wireless infrared port to the PC—Personal computer.

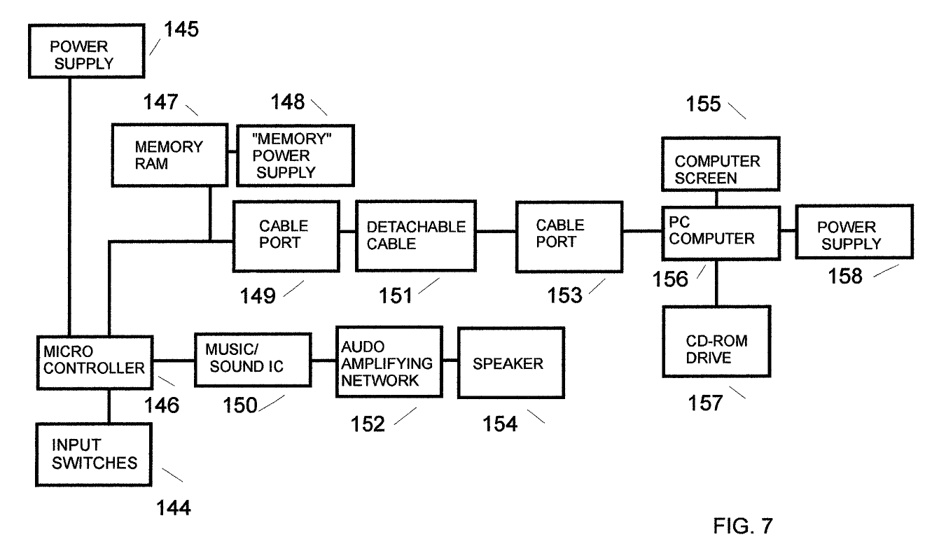

7) FIG. 7 is a detailed block diagram of the guitar using the detachable cable to interface to the PC—Personal computer.

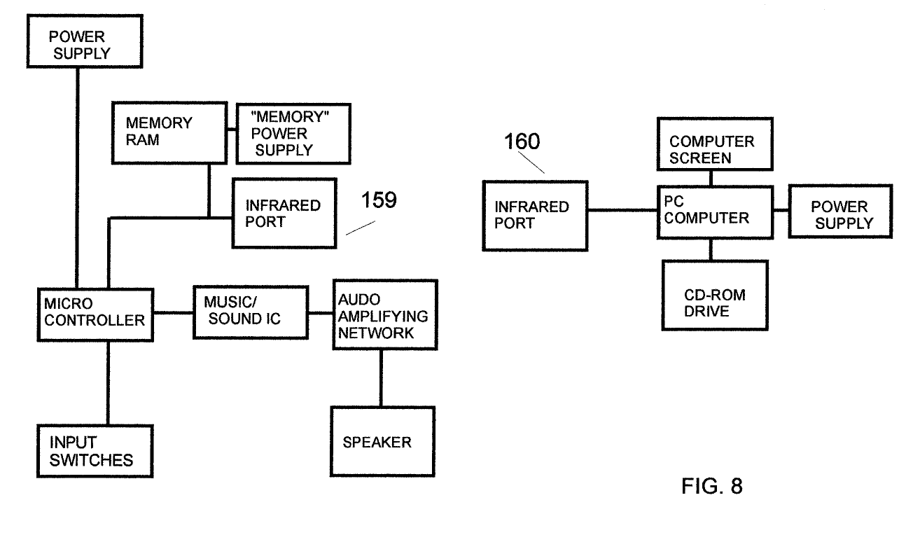

8) FIG. 8 is a detailed block diagram that represents the guitar implementing the wireless infrared port to the PC—Personal computer.

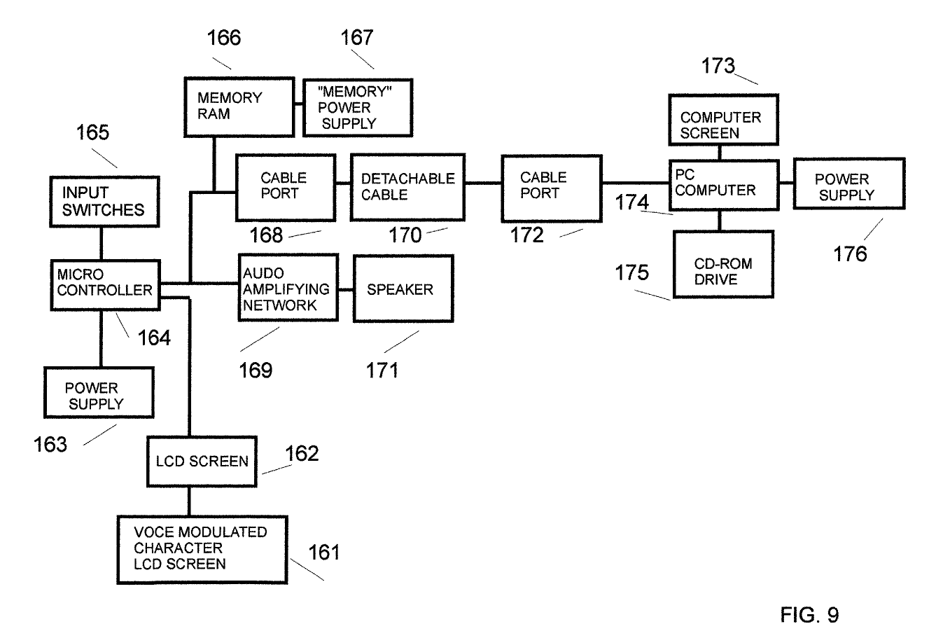

9) FIG. 9 is a detailed block diagram which represents the LCD game using the detachable cable to interface to the PC-Personal computer.

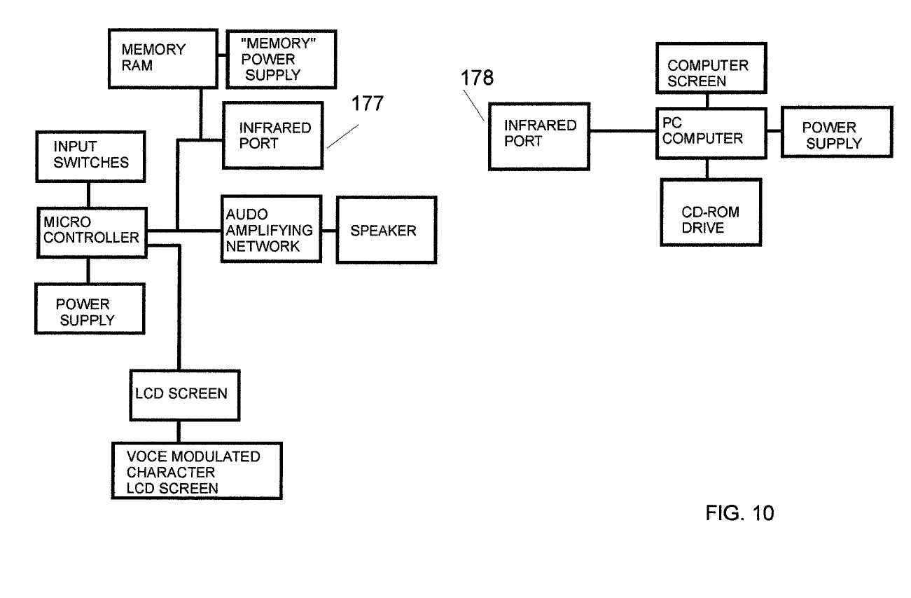

10) FIG. 10 is a detailed block diagram which represents the LCD game using the wireless infrared port to the PC—Personal computer.

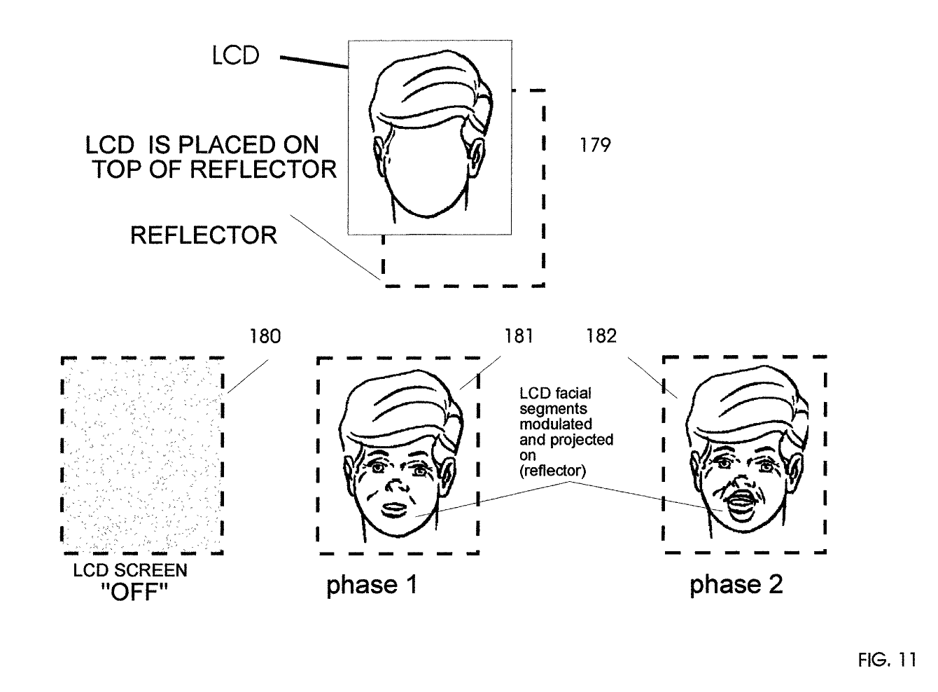

11) FIG. 11 represents the voice modulated animated character LCD option for the LCD game.

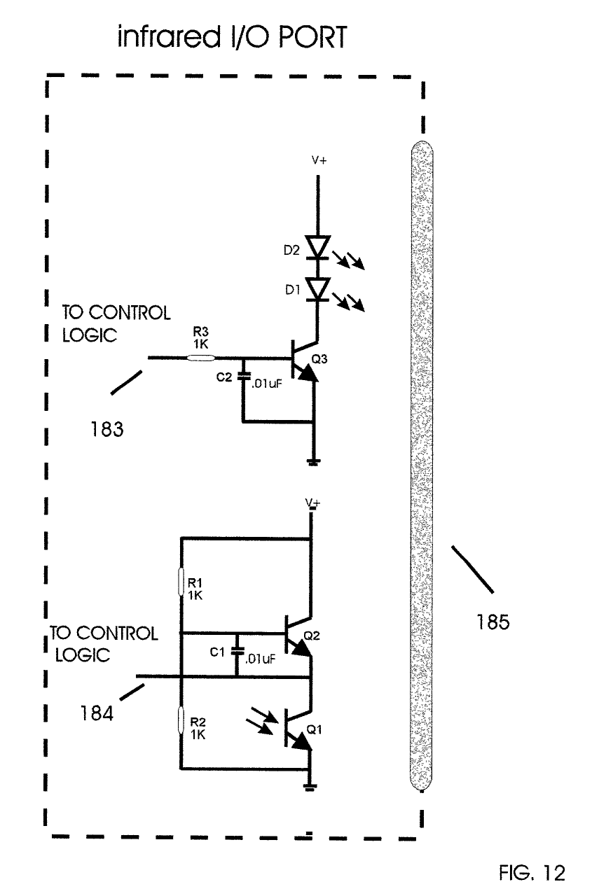

12) FIG. 12 examines the I/O infra-red port that allows wireless transmission of data between units and personal computer.

### DETAILED DESCRIPTION

The present invention will be better understood upon reading the following description of several embodiments and aspects thereof in connection with the drawing & schematics. The first embodiment (FIG. 1) described is as an electronic guitar 100. Please note input buttons 101 to activate the unit for music & sound output. Additionally 106 is the volume control for the audio output. 107 is an additionally control commonly called a “Whammy bar” which can create additionally musical effects such as echo & reverb. The input/output port 102 may accept a detachable cable 103 which can then be attached to the PC 105 via the serial port, parallel port or other port on said computer. This is determined by the adapter used and also how the download software is configured for transmission of data. The CD-ROM 104, is the preferred mode of data storage & access however a floppy disk or internet data base is also a viable means of exchanging & receiving data from said unit. Therefore, 104 CD-ROM is placed in the appropriate CD-ROM drive on the PC 105. It also should be note that those familiar with the art could easily recognize that other musical instruments may be configured using a similar manner, (ie organ, piano, drums, saxophone, etc.).

Another embodiment (FIG. 2) of said invention is as a LCD (LIQUID CRYSTAL DISPLAY) game 108 and 111 respectively. Please note that LCD 110 is a voice modulated animated LCD screen. LCD game 111 does not have this feature included. However, this feature is of particular significance since the multitude of downloaded code can indeed change the voice output of said display as well as the character & game constraints. 110 may change facial features by simply using a different combination of LCD segments. Please note in this example 110 and 109 are separate LCD plates. It should be note that all functions could be include on a single LCD display if so desired. Additionally, the input/output port 112 may accept a detachable cable 113 which can then be attached to the PC 115 via the serial port, parallel port or other port on said computer. This is determined by the adapter to be used and also how the download software is configured for transmission of data, The CD-ROM 114, is preferred mode of data storage & access however, a floppy disk or internet data base is also viable means of exchanging & receiving data from said unit. Therefore, 114 CD is placed in the appropriate CD-ROM drive on the PC 115. it should be noted that those familiar in the art could envision that wireless infrared data transmission may replace the detachable cable & connective ports. Additionally, other game themes may be implemented that do not use an LCD screen but, another graphic display technology such as (i.e. LED or Dot matrix) or not included in the design.

Therefore, the preferred embodiments of said inventions 100, 108, And 111 shall be described in greater technical detail.

FIG. 3 provides an overview of the electronic design for the electronic guitar. The microcontroller 116 will directly interface with I/O port 123. Additionally, the downloaded memory 119 will interface directly with the microcontroller 116 and the music & sound IC 120. It should be noted that the microcontroller 116 will initially accept the downloaded code & subsequently transfer the code to 119. Additionally the Sound IC 120 will access this code & upon activation from the input of the microcontroller will output via Q1, 121 & speaker 122 to create the desired music/sound effect. The digital code will contain digitized sound effects and/or musical “riffs”. Again, the detachable cable 124 will also connect to port 125. The PC 126 will again control the software access from the CD-ROM 127 via the CD-ROM drive 128. Download & upload capability will be facilitated via microcontroller 116 & the PC 126.

FIG. 4 examines another embodiment of the electronic guitar implementing the wireless infrared port option for data transmission. This variation eliminates the need for a detachable cable. The input/output port 129 for the guitar implements an infrared emitter and infrared photo transistor pair. Additionally, port 130 for the PC also uses a similar input/output port which also is comprised of an infrared emitter and infrared photo transistor pair. Therefore, as an example when the downloads code, the information is transmitted via the infrared emitter in port 130. Port 129 will receive said pulses via the infrared photo transistor as mentioned. In an analogous fashion the guitar when uploads code to the PC for storage, the photo emitter associated with port 129 will output the digital information. Said information will be received by the photo transistor of port 130 of the host computer. Hence, this allows both uploading code to the PC as well as downloading code as well. It should be noted that a pin diode, photo diode or other optoelectronic component activated by infrared or near infrared energy than a photo transistor may be used as the receiver input for both ports 129, 130.)

FIG. 5 examines another embodiment of the invention, namely an LCD (LIQUID CRYSTAL DISPLAY) game. Here the Microcontroller 131 interfaces with the LCD screen 136. the Microcontroller 131 has onboard LCD drivers with multiplexed drive capabilities. Additionally 132 input (1-N) are the controls for game play. Q1, 139 and Speaker 140 amplify & output any voice or sound effects associated with game play. Additionally, the input/output port 135 may accept a detachable cable 137 which can then be attached to the PC 139, via the serial port, parallel port or other port on said computer 138. To reiterate, this is determined by the adapter used and also how the download software is configured for transmission of data. The CD-ROM 141, is the preferred mode of data storage & access however, a floppy disk or internet data base is also viable means of exchanging & receiving data from said unit. Therefore, 141 CD-ROM is placed in the appropriate CD-ROM drive of PC 139.

FIG. 6 implements a wireless transmission between the aforementioned LCD game and the host PC. the wireless infrared port option for data transmission. This variation eliminates the need for a detachable cable. The input/output port 142 for the LCD GAME implements an infrared emitter and infrared photo transistor pair. Additionally port 143 for the PC also uses a similar I/O port which also is comprised of an infrared emitter and infrared photo transistor pair. Therefore as an example when the PC downloads code the information is transmitted via the infrared emitter in port 143. Port 142 will receive said pulses via the infrared photo transistor as mentioned. In an analogous fashion the when the LCD game is instructed to upload code to the PC for storage, the photo emitter associated with port 142 will output the digital information. Said information will be received by the photo transistor of the port 143 of the host computer. Hence, This allows both uploading code to the PC as well as downloading code as well. It should be noted that a pin diode, photo diode or other optoelectronic component activated by infrared or near infrared energy than a photo transistor may be used as the receiver input for both ports 142 143.

FIG. 7 uses a full block format to examine the design of one of the preferred embodiments of the invention namely an electronic guitar. Please note the memory power supply 148. 148 serves to maintain the contents of the memory 147 in the event 145 the AC adapter or battery power supply is mistakenly turned off or the batteries simply run out of energy. There are currently a number of memory storage means that will allow downloading and uploading new code. Currently standard RAM (RANDOM ACCESS MEMORY) is the most cost sensitive for said application & therefore a memory power supply is necessary for the above stated reasons. It should be noted that 147 memory may also be a flash memory or EEprom memory modules.

FIG. 8 Is similar to FIG. 7 with the exception of the inclusion of the wireless infrared ports 159 and 160.

FIG. 9 Examines via block diagram another preferred embodiment of the invention namely the LCD game. Again please note the voice modulated character LCD 161 and LCD screen 162. Please note, both LCD's could be combined onto one display or LCD 161 could be eliminated entirely. Therefore as described in FIG. 1, two versions of said invention could occur namely, a unit with a voice modulated character LCD & one which does not include such. Additionally, as with other variations of said invention 167, the memory power supply is critical to the design in the event that the main power supply 163 is interrupted and thus preventing previously downloaded information from being lost or corrupted.

FIG. 10 Exhibits a block diagram of the LCD game using a wireless I/O infrared port 177 and 178.

FIG. 11 Examines in greater detail the voice modulated character LCD. Please note: Discrete LCD segments can be used to create a greater clarity of the image as opposed to a pixelated version. Pixels may also be used if deemed more appropriate for a specific application. Facial segments 181, 182 and accompanying voice/sound output are precisely controlled by the intelligent logic & algorithm of said microcontroller of the unit.

FIG. 12 looks closer at the I/O infrared port. Said port implements two specific channels. Infrared emitters D1 & D2 perform transmission of the data and Q1 or the photo transistor is configured to receive data via infrared transmission. Please note 183 and 184 respectfully. Line 183 will output the appropriate date to be transmitted. Line 184 will input date to have processed by said microcontroller unit. Therefore the infrared port for the preferred embodiments, the LCD game and electronic guitar will be directly hard wired into said units. Please note a similar port shall be installed in the PC. 183 and 184 can interface to the serial port, parallel port or other I/O port on a personal computer or other computer server. Therefore a simple connector will unite the PC infrared port intended for the to the specified port of said computer. 185 is the infrared filter for said infrared port. 185 will attenuate and filter unnecessary ambient room light from interfering from the transmission of data between units. Data will transmit & receive at a rate of approximately 30 KHZ. Please note other frequencies may be used based on the optimal operating frequency of D1, D2 & Q1.

1. An electronic musical instrument such as a guitar, electronic keyboard or drum set (or other musical instrument) with the ability to change the operating code via a “download” and transfer information from a medium such as a CD-ROM, PC computer or internet server.

2. The invention of claim 1, wherein the digital code will enable the musical instrument to output sound and music consisting of preprogrammed musical riffs and notes.

3. The invention of claim 1, wherein an infinite array of different musical styles and variations maybe achieved by implementing this system.

4. The invention of claim 1,wherein sound activation is achieved via input keys, pads or strings dependent upon the style of one of the preferred embodiments of the musical instrument.

5. A Handheld electronic game which would acquire operating code in a similar fashion as stated in claim 1 is also claimed.

6. The ability of said invention/s of claims 1 & claim 5 wherein to be able to customize code and “upload” the information from said musical instrument/handheld game and have the new customized code permanently stored on a PC, internet site or other storage medium for later use or modification.

7. It is also claimed that said transfer of information may use a serial/parallel port or other accessible port of a PC. The connection may be a simple tethered cord connecting invention to PC computer and/or server.

8. Additionally, what also claimed is a wireless infrared port that can both transmit and receive information. Therefore, downloading as well as uploading information is possible.

9. The inventions of claim 1 and claim 5 wherein may also may interact with other units of similar style via a tethered cords of claim 7 or wireless infrared ports of claim 8.

10. A handheld game as stated in claim 5 may also have an LCD screen capable of modification of use and game play by the aforementioned changeable code.

11. Additionally the LCD screen of the handheld game of claim 5 may also have incorporated into the design a multitude of facial caricatures. The code downloaded will actuate said animated LCD face.

12. The customized code and voice/sound output of said LCD face may also be uploaded for storage similar to claim 5.

13. The inventions of claim 1 and claim 5 wherein the power supply may either be battery operated or standard AC power supply.

14. It shall also be claimed that the invention/s of claim 1 and claim 5 will have intelligent logic and a central processing unit which will facilitate data processing & memory storage of the associated code.

15. It also is claimed invention/s of claim 1 and claim 5 wherein once the code is downloaded the invention/s will be fully independent & operational.
